(19) United States
(12) Patent Application Publication
(10) Pub. No.: US 2005/0110191 A1
(43) Pub. Date: May 26, 2005

(54) Package method of phosphoric light emitting diode

(76) Inventor: Jung Kan Lin, Gueishan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/720,525

(22) Filed: Nov. 25, 2003

(51) Int. Cl. B29C 70/88

(52) U.S. Cl. 264/272.11

(57) ABSTRACT

A package method of a LED containing a phosphoric medium is utilizing a liquid phosphoric glue as material and utilizing a casting mold method to encapsulate. During the package process, the liquid phosphoric glue is saturated and the phosphor is precipitated to cover the LED unit for providing a LED package with a phosphoric medium layer cover the LED unit. The phosphoric medium layer is composed of a package glue and a phosphor layer precipitated on bottom to compactly cover the LED unit. The claimed invention can reduce the light-color leakage rate of the LED, standardize the size, stabilize the white-light spectrum, improve the yield and reduce the cost.

### BACKGROUND OF INVENTION

1. Field of the Invention

The invention relates to a package technology of a light emitting diode (LED), and more particularly, to a package method of a white-light LED containing a phosphoric medium.

2. Description of the Prior Art

In general, a LED package structure is achieved by using a transfer molding method or a liquid-glue encapsulating method, and the transfer molding method is the most popular process. The printed circuit board (PCB) or the metal frame equipped with LED die and wires is firstly put into the cavity of the mold, and the ram is utilized to fill the preheated solid epoxy resin into the cavity. After heating, the epoxy resin produces hardening reaction, and the molding encapsulation procedure is completed. And, then, the mold encapsulating substrate is cut into a plurality of LED package devices. However, for the small size LED products, the stuff delivering trough of the transfer molding process is too long and the stuff is always wasted. Furthermore, during the transfer molding process, the pressure of the ram and the flowing speed of the stuff should be precisely controlled to avoid damaging or shorting the wires. This causes the process is complicated and difficult to control.

The liquid-glue encapsulating method uses an encapsulation material that is liquid in room temperature. The glue dispensation machine dispenses the epoxy resin onto the LED substrate, and the glue is heated to solidify. Without a mold, the liquid-glue encapsulating method is cheap and simple, but the surface of glue is difficult to control and the throughput is low. Thus it is not popular.

In addition, while manufacturing the white-light LED package devices, the materials for the two methods are solid phosphoric epoxy resin and liquid phosphoric epoxy resin respectively. No matter what method is used, the package device of both methods is the same as shown in FIG. 1. A LED die 12 is located on a substrate 10 and is covered with a mixture layer 14 composed of a phosphor and an epoxy resin. The phosphor powder 16 is dispersed in the epoxy resin 18 without concentrating upon the LED die 12, so the LED die 12 has a higher light-color leakage rate.

Hence, the present invention provides a package method of a white-light LED containing a phosphoric medium to solve the disadvantage of the prior arts.

### SUMMARY OF INVENTION

It is therefore a primary objective of the claimed invention to provide a package method of a LED containing a phosphoric medium in which the phosphor powder of the phosphoric glue is precipitated over the LED die to effectively reduce the light-color leakage rate of the LED. This will solve the problem of the high light-color leakage rate caused by phosphor powders dispersing in the glue.

It is therefore another objective of the claimed invention to provide a package method of a LED that utilizes a casting mold method to encapsulate the LED and form the LED devices in predetermined size, and further provide a white-light LED with a stable spectrum range to solve the problem of spectrum shift. The present invention can achieve the effect of providing precise luminescence color of white LEDs.

It is therefore a further objective of the claimed invention to provide a package method of a LED that has advantages of standardized size, high yield and suitability for large-size outer mold.

It is therefore a further objective of the claimed invention to provide a package method of a LED that fully utilizes the material to reduce the manufacture cost.

According to the claimed invention, a package method of a phosphoric light emitting diode (LED) comprising steps of providing a substrate and a casting mold, a plurality of LED units are located on the substrate and a plurality of casting units corresponding to the LED units are formed inside the casting mold; placing the substrate into the casting mold to align the LED units with the casting units and fixing the casting mold; stuffing a liquid phosphoric glue containing a phosphor into the casting mold and filling the casting units; and precipitating the phosphor of the liquid phosphoric glue on the LED units and hardening the liquid phosphoric glue to obtain a mold encapsulating substrate.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a cross-sectional diagram of a white-light LED package device according to prior art.

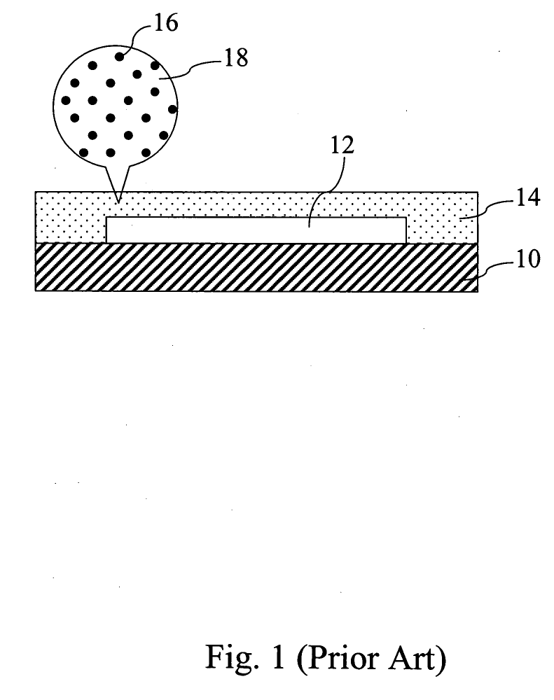

FIG. 2 is a cross-sectional diagram of a LED package device according to present invention.

FIG. 3 is a partial magnified diagram of FIG. 2.

FIG. 4 is a flow chart of the package method according to present invention.

FIG. 5 is a schematic diagram of locating the LED substrate in the mold according to present invention.

FIGS. 6A and 6B are cross-sectional diagrams of proceeding the saturated solidifying step according to present invention.

### DETAILED DESCRIPTION

The claimed package technology of a LED utilizes a liquid phosphoric glue to be a package material, and utilizes the casting mold method and principle of solid sedimentation in saturated liquid to fabricate the LED package structure.

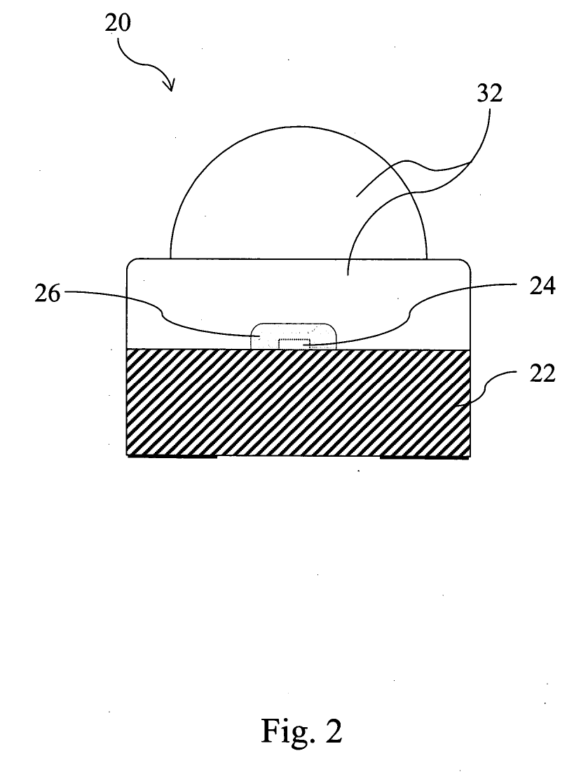

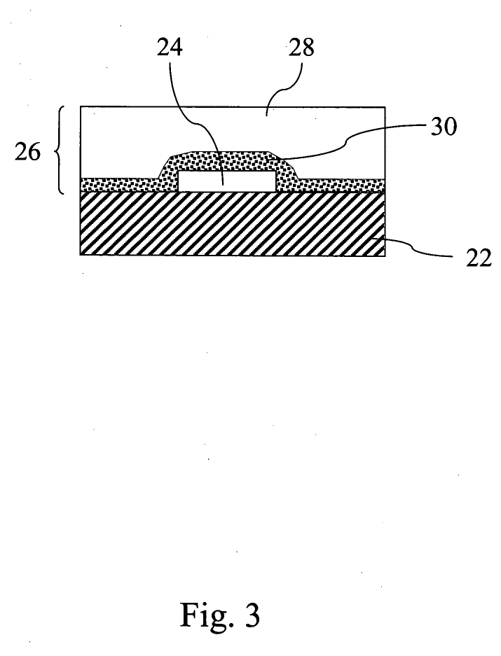

Please refer to FIG. 2, which is a cross-sectional diagram of a LED package device according to present invention. A LED package device 20 comprises a substrate 22, which is normally a printed circuit board (PCB) or a metal frame. A LED unit, such as a LED die 24, is located on the substrate 22, and a phosphoric medium layer 26 covers the LED die 24 on the substrate 22. An outer package glue 32 covers outside the phosphoric medium layer 26. As FIG. 3 shows, the phosphoric medium layer 26 comprises a package glue 28 precipitated a phosphor sediment layer 30 on bottom, and the phosphor sediment layer 30 compactly covers the LED die 24. Materials of the package glue 28 and the outer package glue are normally an epoxy resin, and the phosphor sediment layer 30 is composed of phosphor powders. The phosphor powders and the frequency-fixed LED can refract each other to emit white light.

In contrast to the prior art, the present invention precipitates the phosphor powders on bottom of the package glue can compactly cover the phosphor powders upon the LED unit 12, so that the light-color leakage rate of LED can be effectively reduced.

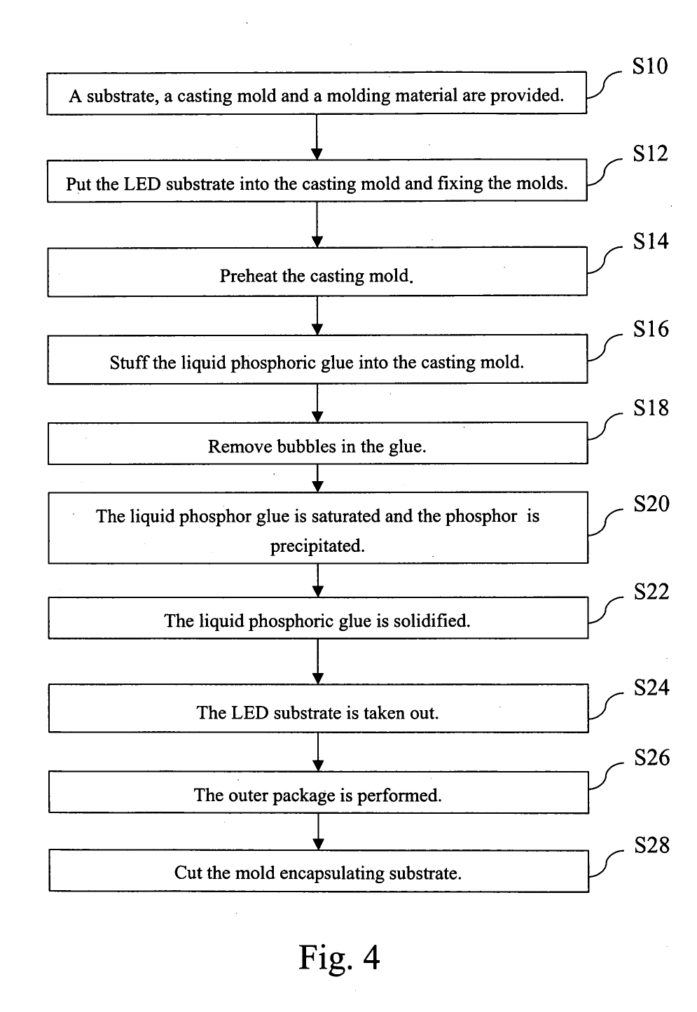

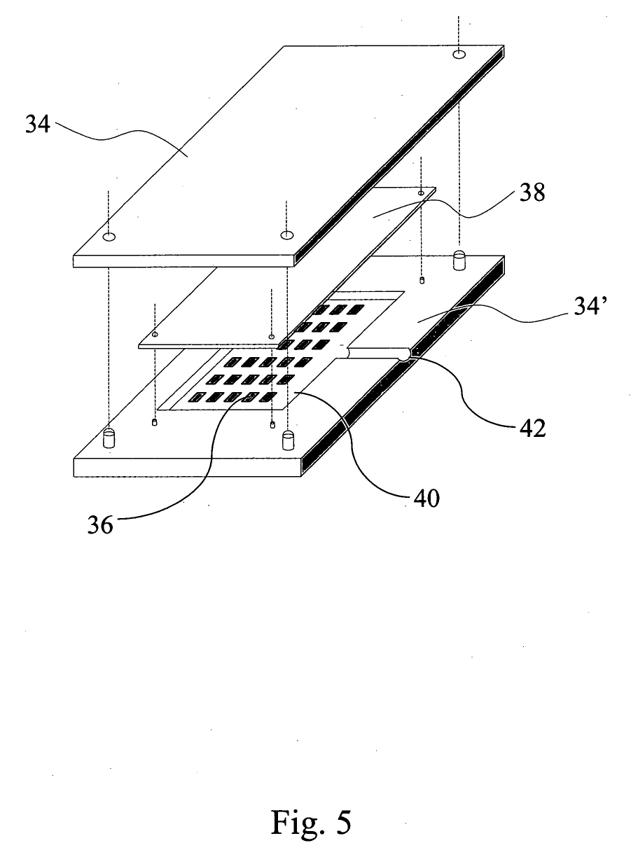

The method utilizing the casting mold method and principle of solid sedimentation in saturated liquid to fabricate the LED package structure is explained hereinafter. Please refer to FIG. 4, which is a flow chart of the package method according to present invention. The package method of the LED comprises steps of: firstly, as step S10 shows, providing a substrate, a casting mold and a molding material, wherein a plurality of LED units are located on the substrate and the LED units are electrically connected to the substrate. FIG. 5 shows the casting mold, which is composed of an upper mold 34 and a lower mold 34′. A plurality of casting units 36 are equipped on an inside surface of the lower mold 34′, and each casting units 36 corresponds to each LED unit on the LED substrate. The molding material is a liquid phosphoric glue composed of a phosphor and a package glue. The package glue is normally an epoxy resin and the phosphor is normally phosphor powders.

After preparing the LED substrate, the casting mold and the molding material, as shown in FIG. 5 and step S12, the mold releasing oil is spread on the inside surfaces of the upper and lower mold 34, 34′, and the LED substrate is faced down and located in the fillister 40 of the lower mold 34′. The LED units are corresponded with the casting units 36 of the lower mold 34′ and fixing the molds 34, 34′.

After fixing the molds, as step S14 shows, the casting mold is preheated to a predetermined temperature, then, step S16, the liquid phosphoric glue is stuffed into the casting mold through a stuffing pipeline 42 and filled the casting units 36. Then as step S18 shows, a step of removing bubbles is performed in an automatic vacuum oven with predetermined air pressure, temperature and time.

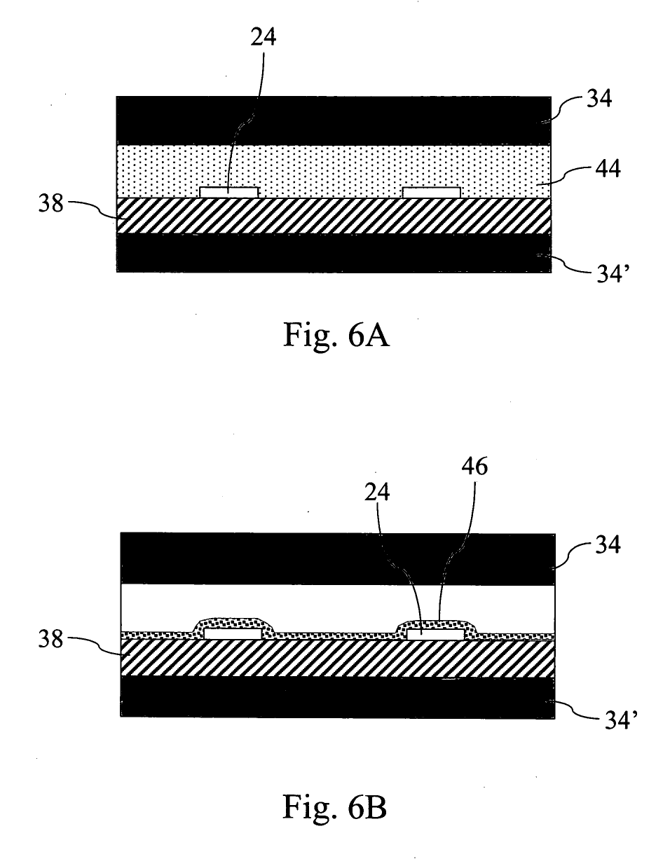

After removing bubbles, the step S20 is performed as shown in FIGS. 6A, 6B. The liquid phosphor glue 44 is saturated and the phosphor 46 is precipitated to cover the LED die 24. The method for saturating the liquid phosphoric glue 44 is utilizing changing temperature to lead the phosphor powders precipitating, and utilizing the gravity to cover the phosphor powders upon the LED die 24. The temperature and time are determined in accordance with the concentration of liquid phosphoric glue 44, the density of phosphor powders, and the size of flowing pipeline.

Then, as shown in step S22, the liquid phosphoric glue 44 is heated to solidify with a curing reaction. After solidifying the glue, the casting mold is opened and the LED substrate is taken out to clean, and a mold encapsulating substrate is obtained.

After obtaining the mold encapsulating substrate, as step S26 shows, the outer package is performed. An outer package glue is formed outside the solidified phosphoric glue. The package method is similar to steps S10 to S24 mentioned above but omitting the precipitating step. The outer package glue is a monophase liquid, such as a epoxy resin.

Finally, after finishing the inner and outer package, as shown in step S28, a step of cutting the mold encapsulating substrate into a plurality of LED package devices in accordance with the LED die. The whole package flow is completed and a LED package device is obtained.

In the claimed package method, the casting mold has a fixed size to fabricate a LED product with fixed size, and the white-light LED produces a white light of specific spectrum only with a specific size. The claimed invention can effectively standardize the packaging size to improve the yield, and is suitable for fabricating products of large-size outer mold. The present invention has advantages of standard size and accurate light-color. In addition, since the present invention gives up the transfer molding method of the prior art, the material can be effectively utilized to 90%. The present invention improves the utility rate 30% more than that of the transfer molding method. The material can be saved and the packaging cost can be substantially reduced.

Those skilled in the art will readily observe that numerous modifications and alterations of the device may be made while retaining the teachings of the invention. Accordingly, the above disclosure should be construed as limited only by the metes and bounds of the appended claims.

| | |
|---|---|
| 10 substrate | 12 LED die |
| 14 mixture layer | 16 phosphor powder |
| 18 epoxy resin | 20 LED package device |
| 22 substrate | 24 LED die |
| 26 phosphoric medium layer | |
| 28 package glue | 30 phosphor sediment layer |
| 32 outer package glue | |
| 34 upper mold | 34′ lower mold |
| 36 casting unit | 38 LED substrate |
| 40 fillister | 42 stuffing pipeline |
| 44 liquid phosphor glue | |
| 46 phosphor | |

1. A package method of a phosphoric light emitting diode (LED) comprising steps of:
providing a substrate and a casting mold, a plurality of LED units are located on the substrate and a plurality of casting units corresponding to the LED units are formed inside the casting mold;
placing the substrate into the casting mold to align the LED units corresponding with the casting units and fixing the casting mold;
stuffing a liquid phosphoric glue containing a phosphor into the casting mold to fill the casting units; and
precipitating the phosphor of the liquid phosphoric glue on the LED units and hardening the liquid phosphoric glue to obtain a mold encapsulating substrate.

2. The package method of claim 1 wherein the liquid phosphoric glue is composed of the phosphor and a package glue.

3. The package method of claim 2 wherein the package glue is an epoxy resin.

4. The package method of claim 1 wherein the phosphor is phosphor powders.

5. The package method of claim 1 wherein, after fixing the casting mold and before stuffing the liquid phosphoric glue, further comprises a step of preheating the casting mold.

6. The package method of claim 1 wherein the step of precipitating the phosphor is saturating the liquid phosphoric glue and precipitating the phosphor.

7. The package method of claim 1 wherein the step of hardening the liquid phosphoric glue is heating the liquid phosphoric glue after precipitating the phosphor and curing the liquid glue portion of the liquid phosphoric glue.

8. The package method of claim 1 wherein, after obtaining the mold encapsulating substrate, further comprises a step of cutting the mold encapsulating substrate into a plurality of LED package devices in accordance with the LED units.

9. The package method of claim 1 wherein the casting mold is composed of two molds, and the casting unit is formed on an inside surface of one of the molds.

10. The package method of claim 1 wherein, after stuffing the liquid phosphoric glue, further comprises a step of removing bubbles.

11. The package method of claim 1 wherein, after obtaining the mold encapsulating substrate, an outer package glue can be further formed outside the hardened liquid phosphoric glue with a casting mold method.
